(19) United States
(12) Patent Application Publication
(10) Pub. No.: US 2019/0311305 A1
(43) Pub. Date: Oct. 10, 2019

(54) SYSTEM AND METHOD FOR AUTOMATED PROMOTION AND RESERVATION OF APPOINTMENT-BASED SERVICES

(71) Applicant: Tapyn Corporation, Seoul (KR)

(72) Inventor: JAEYONG LEE, Seoul (KR)

(21) Appl. No.: 16/376,846

(22) Filed: Apr. 5, 2019

(30) Foreign Application Priority Data
Apr. 5, 2018 (KR) 10-2018-0039564

(51) Int. Cl. G06Q 10/02; G06Q 30/02; G06N 20/00; G06N 5/04

(52) U.S. Cl. CPC G06Q 10/02; G06Q 30/0255; G06N 5/04; G06N 20/00; G06Q 30/0267

(57) ABSTRACT

Provided is a system and method for automating the promotion and reservation of an appointment-based service. The system includes an appointment management database configured to store service schedules, customer information, and promotion history information; an automatic promotion and appointment processing server configured to select target customers who have a good possibility of using an idle resource and a promotion service item of the idle resource when the idle resource is recognized, and to provide the selected promotion service items to the target customers; and a customer terminal configured to present the promotion service item of the idle resource provided by the automatic promotion and appointment processing server, and to provide a request, a denial, or a change for an appointment through the Internet, a mobile communication network, or a communication network formed of a combination of heterogeneous communication networks.

### CROSS-REFERENCE TO RELATED APPLICATION

This application is based on and claims priority under 35 U.S.C. 119 to Korean Patent Application No. 10-2018-0039564, filed on Apr. 5, 2018, in the Korean Intellectual Property Office, the disclosure of which is herein incorporated by reference in its entirety.

### BACKGROUND OF THE DISCLOSURE

### 1. Technical Field

The present disclosure relates to a system and method for automating the promotion and appointment, or reservation, of appointment-based services, wherein a customer's immediate appointment is induced by promoting an idle resource to optimal target customers in a business establishment where appointment-based services are provided, and a series of processes of receiving and confirming the customer appointments are automated.

### 2. Description of the Related Art

In business establishments where appointment-based services are primarily provided to customers, such as a beauty shop, a healthcare provider's office, and an auto repair shop, appointment management is very important for customer satisfaction and efficient use of available service resources for providing customers with services. A service resource includes a service provider such as a hairstylist, a doctor and a maintenance technician who provide specific services to customers, and/or a service environment exclusively used for the provision of each service such as a clinic room or a vehicle lift.

Particularly, from the viewpoint of an appointment-based service provider, it is desirable to minimize the time during which a service appointment has not been scheduled and an available service resource of the business establishment is not used, i.e., an idle resource. To this end, a service business may perform a promotion of an idle resource, including an inducement such as a price discount, with respect to potential customers. However, conducting generic promotion to many unspecified customers without clear targeting may result in cost inefficiency and many customers receiving indiscriminate promotions may feel inconvenienced.

### SUMMARY OF THE DISCLOSURE

An object of the present disclosure is to provide a system and method for automating the promotion and reservation of appointment-based services, which can improve a customer's response rate and appointment rate by selecting a small number of target customers determined to be optimal for the idle resources based on machine learning and to perform automated promotion on only the corresponding target customers in order to minimize the idle resources of a business establishment for appointment-based services.

Another object of the present disclosure is to provide a system and method for automating the promotion and reservation of appointment-based services, which can maximize the operation efficiency and sales of a business establishment by enabling a target customer who has received a service promotion notification to use a communication method suitable for an immediate response thereto, and by automating the analysis of the response and the corresponding appointment processing or scheduling.

Yet another object of the present disclosure is to provide a system and method for automating the promotion and reservation of appointment-based services, which can continue to improve accuracy in the selection of target customers for each idle resource by accumulating customers' responses to service promotions and using the responses in machine learning for selecting optimal promotion target customers in the future.

A system for automated promotion and reservation an of appointment-based service according to an embodiment of the present disclosure includes: an appointment management database configured to store a service schedule, customer information, and promotion history information; and an automatic promotion and appointment processing server configured to select a target customer able to use an idle resource and a promotion service item of the idle resource, and to provide the promotion service item to a customer terminal, wherein the idle resource is a service resource for providing the appointment-based service without a scheduled appointment for a specific period of time, wherein the customer terminal is configured to present the promotion service item of the idle resource provided by the automatic promotion and appointment processing server, and to provide a request, a denial or a change for an appointment from the target customer through the Internet, a mobile communication network, or a communication network formed of a combination of heterogeneous communication networks.

In another embodiment, the automatic promotion and appointment processing server includes: an idle resource identification circuit configured to identify the idle resource from one or more service resources based on a set of criteria for determining the idle resource; a promotion service recommendation circuit configured to select the target customer able to use the idle resource and the promotion service item for the corresponding idle resource; a promotion notification transceiver circuit configured to transmit a promotion notification of the promotion service item to the target customer selected by the promotion service recommendation circuit and to receive a response from the target customer if the response is present; a customer response analysis circuit configured to analyze the target customer's response to the promotion notification recommended and transmitted to the target customer, classify the customer's response as an appointment request when the target customer's response includes content to request the appointment, classify the target customer's response as a promotion denial when the target customer's response includes a denial of the promotion notification, and to classify the target customer's response as an administrator review that requires a confirmation by an administrator when a requested service resource or idle resource included in the target customer's response is different from the service resource or the idle resource included in the promotion notification transmitted to the target customer; a promotion appointment processing circuit configured to schedule the appointment when the customer response analysis circuit classifies the target customer's response to the promotion notification as the appointment request and to transmit the scheduled appointment to the target customer; a promotion denial processing circuit configured to mark customer information stored in the appointment management database as promotion notification denial when the customer response analysis circuit classifies the target customer's response as the promotion denial; and an administrator notification circuit configured to provide the customer's response to an administrator terminal when the customer response analysis circuit classifies the target customer's response as the administrator review.

In another embodiment, the appointment management database includes: a service schedule database configured to store details of past services and future appointment schedules; a customer information database configured to store information on customers who use the one or more service resources; and a promotion history information database configured to store information of promotion notifications provided to the customers and customers' response times and response types to the promotion notifications, wherein the customer information includes a name and telephone number of the customer, a unique ID or username of a messenger or social network service preferred by the customer, information on whether the customer wants to receive promotion notifications, and a method for the customer to receive promotion notifications.

In another embodiment, the set of criteria for determining the idle resource in the idle resource identification circuit includes a time gap from a current time and a minimum time duration that can be determined as the idle resource.

In another embodiment, the promotion service recommendation circuit includes: a machine learning circuit configured to analyze customer information and promotion history information stored in the appointment management database and to execute machine learning so that a plurality of target customers expected to have a highest selection rate for accepting promotion notifications is predicted when the idle resource is identified among the one or more service resources, and a recommendation execution circuit configured to select the target customer and the corresponding promotion service item of the idle resource predicted by the machine learning circuit when the corresponding idle resource is identified.

In another embodiment, the promotion notification transceiver circuit transmits the promotion notification in a real-time notification form to a dedicated terminal installed on a customer side based on a notification method registered in customer information, transmits the promotion notification in a message form through SMS or MMS, or transmits the promotion notification using a different messaging service requested by the customer as the method of receiving the promotion notification by the customer.

Meanwhile, a method for automating promotion and reservation of appointment-based services according to an embodiment of the present disclosure includes: a first step of setting, by an automatic promotion and appointment processing server, a condition for determining an idle resource, wherein the idle resource is a service resource for providing the appointment-based service without a scheduled appointment for a specific period of time; a second step of recognizing, by the automatic promotion and appointment processing server, the idle resource satisfying the set condition; a third step of automatically recommending, by the automatic promotion and appointment processing server, a target customer according to a machine learning-based algorithm when the idle resource is recognized; a fourth step of transmitting, by the automatic promotion and appointment processing server, a promotion notification to a customer terminal of the target customer; a fifth step of analyzing and classifying, by the automatic promotion and appointment processing server, a received response by type when the response is received from the customer terminal; and a sixth step of handling, by the automatic promotion and appointment processing server, the received response by type, wherein in the fifth step, the target customer's response is classified as an appointment request when content to request an appointment is included in the target customer's response, the target customer's response is classified as a promotion denial when a denial of promotion notification is included in the content, and the target customer's response is classified as an administrator review that requires a confirmation by an administrator when a requested service resource or idle resource included in the target customer's response is different from the service resource or the idle resource of the promotion notification transmitted to the target customer, and wherein in the sixth step, a corresponding appointment is registered with a service schedule database when the target customer's response is classified as the appointment request, promotion notification reception denial is registered with a customer information database when the target customer's response is classified as the promotion denial, and the target customer's response is provided to the administrator when the target customer's response is classified as the administrator review.

In another embodiment, the method according to the present disclosure further includes: transmitting, by the automatic promotion and appointment processing server, a corresponding confirmation notification to the target customer using a communication method requested by the target customer after classifying and handling of the target customer's response; and storing, by the automatic promotion and appointment processing server, the target customer's response contents and results regarding classifying and handling of all the target customer responses in an appointment management database.

### BRIEF DESCRIPTION OF THE DRAWINGS

FIG. 1 is a schematic diagram of a system for automating the promotion and reservation of appointment-based services according to an embodiment of the present disclosure.

FIG. 2 is a block diagram of an appointment management database (DB) according to an embodiment of the present disclosure.

FIG. 3 is an exemplary diagram of a service schedule for a service resource according to an embodiment of the present disclosure.

FIG. 4 is a block diagram of an automatic promotion and appointment processing server according to an embodiment of the present disclosure.

FIGS. 5 and 6 are exemplary diagrams of promotion notifications and customer response messages classified as appointment requests according to an embodiment of the present disclosure.

FIG. 7 is an exemplary diagram of a promotion notification and customer response messages classified as administrator reviews according to an embodiment of the present disclosure.

FIG. 8 is a flowchart illustrating a process of automating the promotion and reservation of appointment-based services according to an embodiment of the present disclosure.

### DESCRIPTION OF REFERENCE NUMERAL

100: appointment management DB

110: service schedule DB 120: customer information DB

130: promotion history information DB

200: automatic promotion and appointment processing server

210: idle resource identification circuit

220: promotion service recommendation circuit

221: machine learning circuit

222: recommendation execution circuit

230: promotion notification transceiver circuit

240: customer response analysis circuit

250: promotion appointment processing circuit

260: promotion denial processing circuit

270: administrator notification circuit

300: customer terminal

### DETAILED DESCRIPTION

Hereinafter, a system and method for automating the promotion and reservation of appointment-based services according to detailed embodiments of the present disclosure are described with reference to the accompanying drawings. In describing the present disclosure, a detailed description of a related known function or configuration will be omitted if it is deemed to make the gist of the present disclosure unnecessarily vague. Furthermore, terms to be described hereunder have been defined by taking into consideration functions in the present disclosure, and may be different depending on a user, an operator's intention or practice. Accordingly, each term should be defined based on contents over the entire specification.

Furthermore, the following embodiments of the present disclosure are described chiefly based on a function configuration that needs to be additionally provided for the present disclosure by omitting an already provided system function configuration or a system function configuration commonly included in the field to which the present disclosure pertains in order to efficiently describe technical elements configuring the present disclosure. A person having ordinary skill in the art to which the present disclosure pertains may easily understand the function of a conventional element in function elements omitted without being shown below. Furthermore, the person may evidently understand the relation between the omitted element and an element added for the present disclosure.

Furthermore, in the following description, terms, such as “transmission”, “communication”, “sending” or “receiving” of a signal or information, or a similar term includes the delivery of a signal or information from one element to the other element via a third element, in addition to the direct delivery of a signal or information from one element to the other element. Particularly, to “transmit” or “send” a signal or information to one element indicates the final destination of the signal or information and does not necessarily mean a direct destination. The same is true of the “reception” of a signal or information.

Embodiments of the present disclosure are described below with reference to the accompanying drawings.

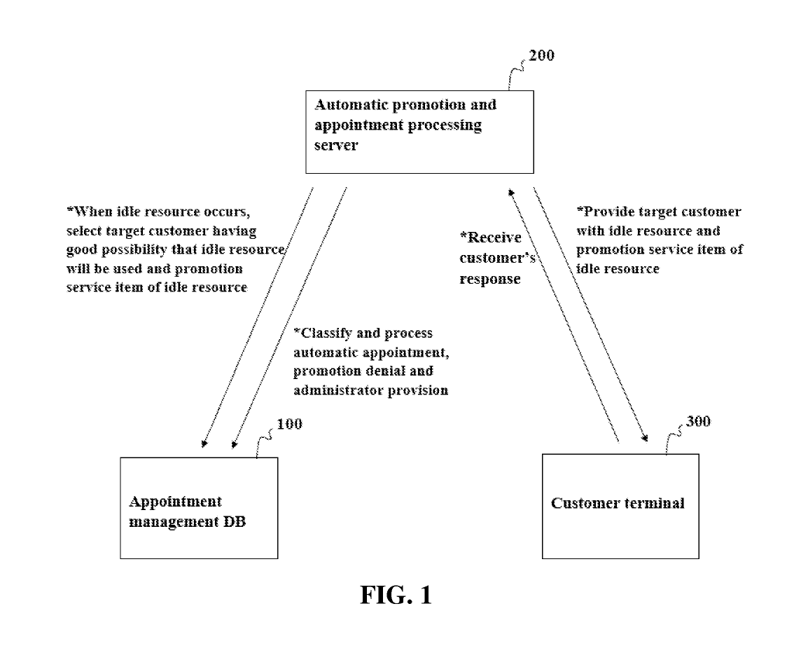

As shown in FIG. 1, a system for automating the promotion and reservation of appointment-based services according to an embodiment of the present disclosure includes an appointment management database (DB) 100 configured to store service schedules, customer information, and promotion history information, an automatic promotion and appointment processing server 200 configured to select target customers who have a higher possibility of using an idle resource when it is recognized and a promotion service item for each of the target customers, and to provide this information of the selected promotion service item to the target customers, and a customer terminal 300 configured to present the promotion service item of the idle resource provided by the automatic promotion and appointment processing server 200, and to provide a customer response, such as an appointment request or denial through the Internet, a mobile communication network or a communication network formed of a combination of heterogeneous communication networks. In this case, the customer terminal 300 may operate in various devices, such as a PC, PDA, laptop computer, tablet PC and smartphone. A plurality of the customer terminals may be existing at the same time. The promotion and appointment automation system according to an embodiment of the present disclosure may use a dedicated client installed on the customer terminal side, or may perform communication using a separate messaging service available for the customer.

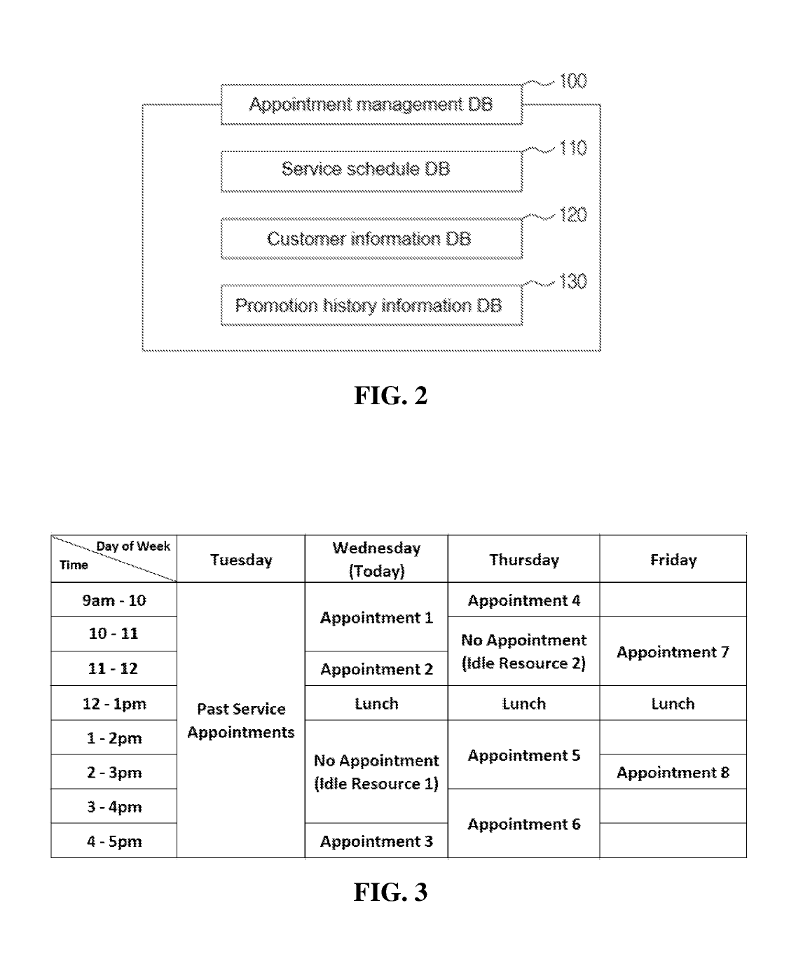

As shown in FIG. 2, the appointment management DB 100 includes a service schedule database (DB) 110, a customer information DB 120, and a promotion history information DB 130.

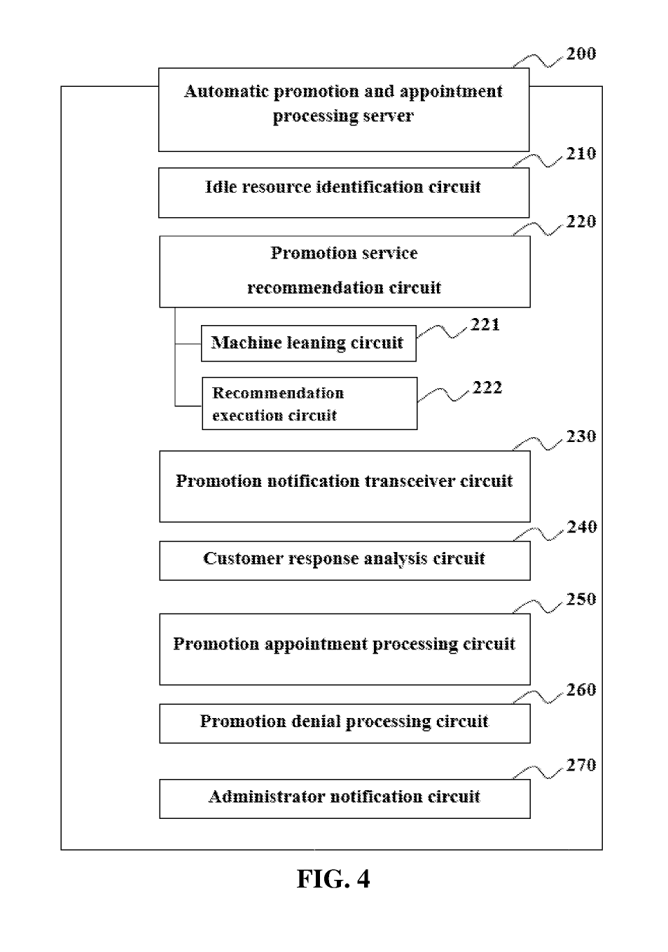

The service schedule DB 110 stores the details of the past services and future appointment schedules, and stores service resources, customers, dates, days of the week, time, service item information, etc., for each service record. For example, as shown in FIG. 3, assuming that the current time is Wednesday 9 a.m. with respect to a certain service resource, the Tuesday's schedule is information of the past service history and subsequent schedules are service appointment schedules, and 3 hours this (Wednesday) afternoon and 2 hours tomorrow (Thursday) morning may be classified as idle resources.

The customer information DB 120 stores information on customers who use service resources. The customer information includes the name and telephone number of the customers, the unique ID or username of a messenger or social network service preferred by the customer, information on whether the customer wants to receive promotion notifications, a method for the customer to receive promotion notifications, etc.

The promotion history information DB 130 stores promotion notification information provided, or offered, to the customers and information on the customers' response times and response types to the promotion appointment information.

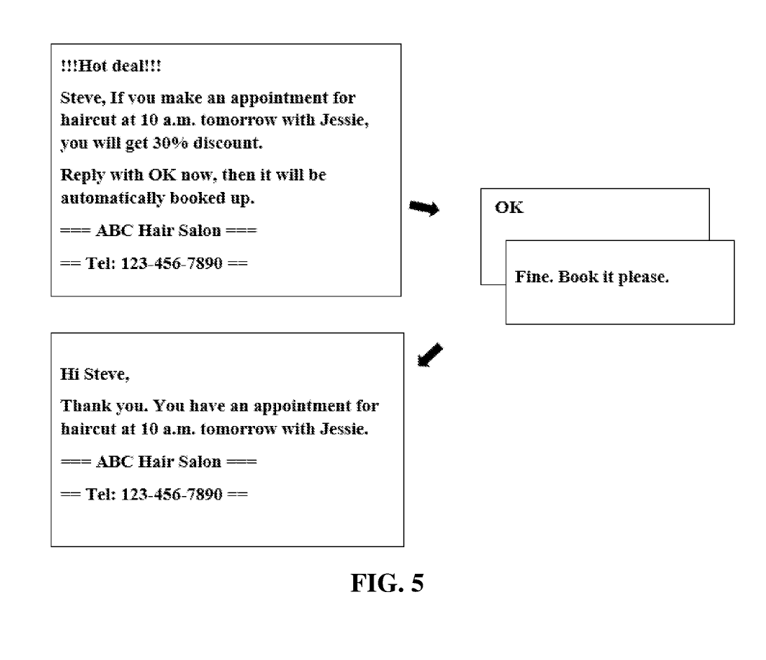

As shown in FIG. 4, the automatic promotion and appointment processing server 200 includes an idle resource identification circuit 210, a promotion service recommendation circuit 220, a promotion notification transceiver circuit 230, a customer response analysis circuit 240, a promotion appointment processing circuit 250, a promotion denial processing circuit 260, and an administrator notification circuit 270.

The idle resource identification circuit 210 identifies an idle resource based on a set criterion for determining the idle resource. The criterion for determining an idle resource may include a time gap from the current time and a minimum time duration of the idle resource.

The promotion service recommendation circuit 220 selects target customers who have a higher possibility of using an idle resource when it is recognized, and also selects a promotion service item for the corresponding idle resource. The promotion service recommendation circuit 220 includes a machine learning circuit 221 and a recommendation execution circuit 222.

The machine learning circuit 221 analyzes information stored in the appointment management DB 100, and executes machine learning so that a plurality of target customers expected to have the highest selection rate for a promotion notification can be predicted when an idle resource is identified amongst the service resources. For example, the machine learning circuit 221 executes machine learning by analyzing the service schedule DB 110 of the past service resources used and customer information by date and/or time. It is noted that a customer may reply differently depending on how much a specific promotion is necessary and advantageous for the customer and tendency thereof may vary over different times. Accordingly, responses to the promotion notification of each customer may need to be continuously incorporated into machine learning.

When an idle resource is identified, the recommendation execution circuit 222 selects target customers and promotion service items for each of the corresponding idle resource derived by the machine learning circuit 221. In this case, the recommendation execution circuit may as well write the name of the target customer in the selected promotion service item.

The promotion notification transceiver circuit 230 transmits the notification of a promotion service item to target customers selected by the promotion service recommendation circuit 220, and receives responses thereto from the target customers if the responses are present. As examples, promotion notifications to target customers may be transmitted via real-time notification function of a dedicated terminal installed on the customer side registered in the customer information, in a message form through SMS or MMS, or a different messaging service requested by the customer.

The customer response analysis circuit 240 analyzes target customers' responses to promotion notifications recommended and transmitted to the target customers, and classifies the target customers' intention by type. The customer response analysis circuit 240 reads the customers' responses using keyword recognition or natural language processing. If content to request an appointment is included in the customer's response, the customer response analysis circuit 240 classifies the customer's response as an appointment request. If the content include the denial of the promotion notification, the customer response analysis circuit 240 classifies the customer's response as a promotion denial. If a service resource for the customer's response is different from the service resource or idle resource provided in the promotion service item, the customer response analysis circuit 240 classifies the customer's response as an administrator review that requires an additional administrator's confirmation. For example, when a promotion service item transmitted to a customer corresponds to an idle resource with a specific time and a specific service resource and the customer's response includes “OK” or “Fine”, or if the time in the customer's response falls within the promoted idle resource, the customer response analysis circuit 240 identifies the customer's response as an appointment request. If “reception denial” or “promotion denial” is identified in the customer's response, the customer response analysis circuit 240 identifies the customer's response to be a promotion notification denial. If the customer's response has a different service resource or a time other than the service resource and idle resource offered for the promotion service item, the customer response analysis circuit 240 may classify the customer's response as an administrator review.

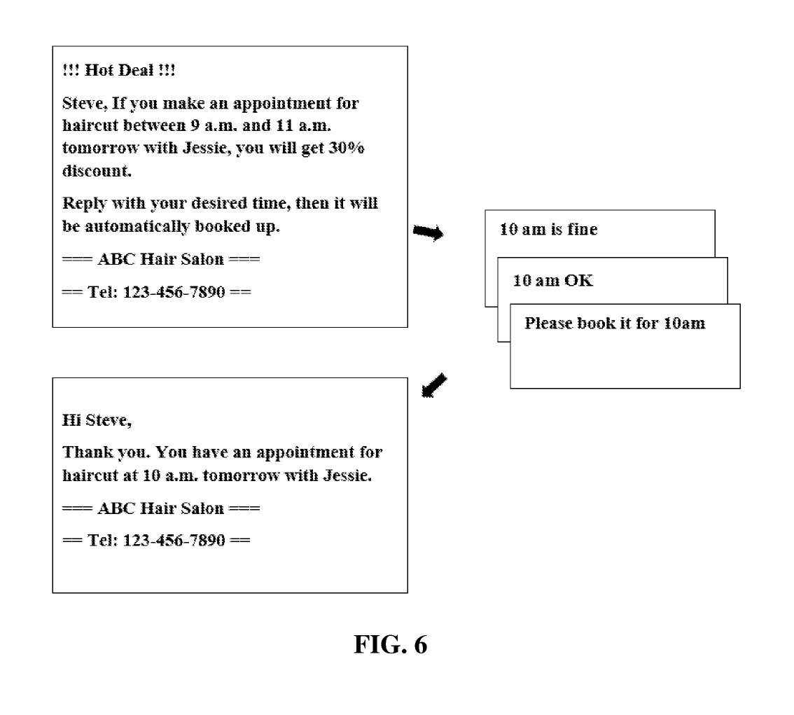

When the customer response analysis circuit 240 classifies a customer's response type as an appointment request to the promotion notification, the promotion appointment processing circuit 250 executes, or schedules, an appointment and transmits the scheduled appointment result to the customer. For example, as shown in FIG. 5, when a promotion service item transmitted to a customer corresponds to an idle resource of a specific time (10 a.m. tomorrow) for a specific service resource (hairstylist: Jessie), and “OK” or “Fine” is identified in the customer's response and the customer's response is classified as an appointment request, then the promotion appointment processing circuit 250 identifies the appointment situation in real time and schedules an appointment if an appointment has not been made for the idle resource, or if an appointment has already been made for the idle resource, notifies the customer that the appointment is not possible. Furthermore, as shown in FIG. 6, when a promotion service item transmitted to a customer corresponds to an idle resource with a range of time (9 a.m.-11 a.m. tomorrow) for a specific service resource (hairstylist: Jessie), and the customer's response is classified as an appointment request as being within the range of the idle resource offered (“10 a.m. OK” or “10 a.m. Fine”), then the promotion appointment processing circuit 250 checks the appointment situation in real time for the idle resource requested by the customer, schedules an appointment if the idle resource is still available, or if another appointment has already been made for the idle resource or if the idle resource has otherwise become unavailable, provides notification that the appointment is not possible.

When the customer response analysis circuit 240 classifies a customer's response type as a denial of promotion notification, the promotion denial processing circuit 260 marks customer information, stored in the customer information DB 120, with promotion notification reception denial. Accordingly, promotion notification is no longer provided to a customer marked with promotion notification reception denial.

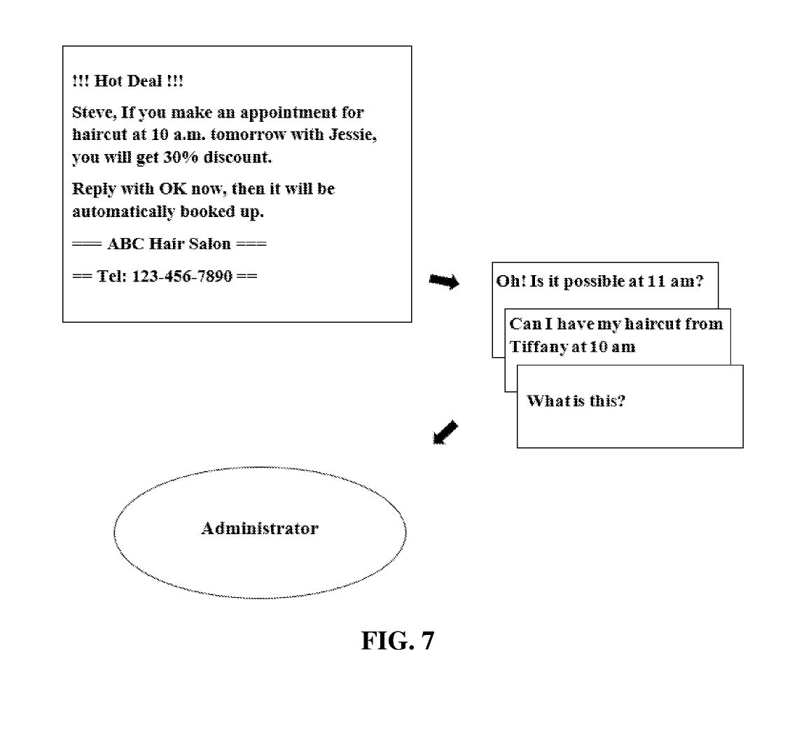

When the customer response analysis circuit 240 classifies a customer's response type as administrator review, the administrator notification circuit 270 provides the customer's response to an administrator terminal. For example, as shown in FIG. 7, if a promotion service item transmitted to a customer corresponds to an idle resource of a specific time (10 a.m. tomorrow) and of a specific service resource (hairstylist: Jessie), and the content in the customer's response has a different service resource and/or idle resource from the service resource and idle resource offered for the promotion notification (E.g., “Can I have my haircut from Tiffany at 10 a.m.?”), then the customer's response is classified as an administrator review. The administrator notification circuit 270 provides the customer response to an administrator terminal. Accordingly, the administrator may identify the promotion service item and the customer's response and take proper measures.

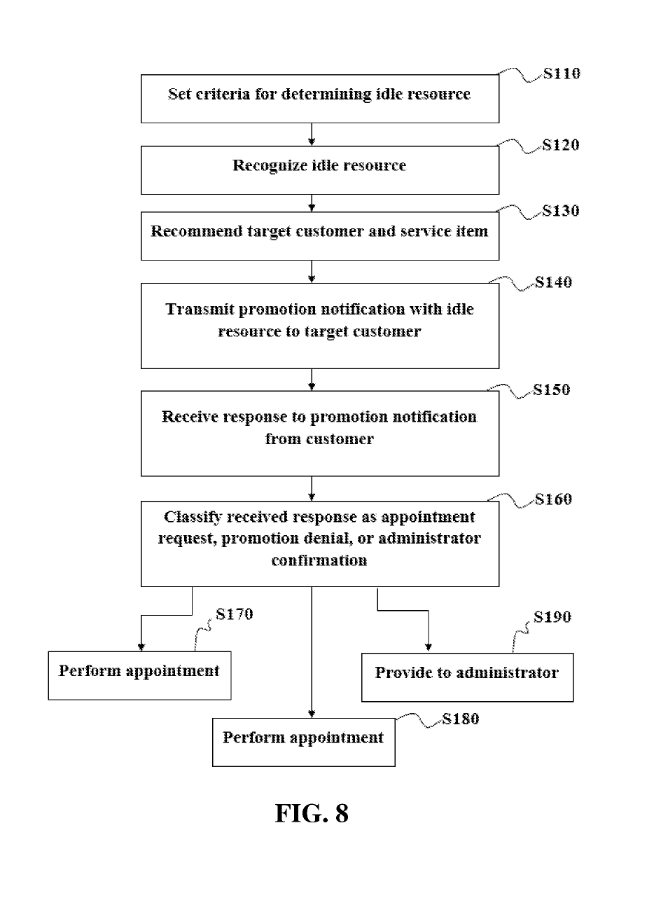

A promotion and appointment automation process according to an embodiment of the present disclosure is described below with reference to FIG. 8.

First, the automatic promotion and appointment processing server 200 sets a certain set of criteria for automatically determining an idle resource for a business establishment where appointment-based services are provided (S110). For example, the criteria may include a time gap from the current time and a minimum time duration determined for an idle resource. For example, the time gap from the current time to identify an idle resource may be set as 4 hours minimum and may be up to 2 days maximum. The minimum time duration that can be determined as an idle resource may be set as 1 hour.

The automatic promotion and appointment processing server 200 searches appointment records of service resources, registered with the service schedule DB 110, for identifying an idle resource based on the predetermined set criterion. If, as a result of the search, an idle resource is recognized (S120), the automatic promotion and appointment processing server 200 automatically recommends target customers and corresponding promotion service items for the recognized idle resource according to a machine learning-based recommendation algorithm (S130).

Furthermore, the automatic promotion and appointment processing server 200 transmits, to the recommended target customers, promotion notifications including information of the idle resource to be promoted such as the service resource and the service time (S140). In this case, the transmission of the promotion notification may be performed using SMS or MMS as registered with the customer information DB 120, a different messaging service desired by the customer, or a dedicated client app.

Meanwhile, when a response to the promotion notification is received from the customer (S150), the automatic promotion and appointment processing server 200 classifies the received response by type (S160). In this case, the automatic promotion and appointment processing server 200 analyzes the customer's response using keyword recognition or natural language processing. The automatic promotion and appointment processing server 200 classifies the customer's response as an appointment request when content to request an appointment is included in the customer's response, classifies the customer's response as a promotion denial when the denial of the promotion notification is included in the customer's response, and classifies the customer's response as an administrator review that requires an additional administrator's confirmation when a service resource for the customer's response is different from the service resource or the idle resource offered to the target customer with the promotion notification.

In this case, when the customer's response type is classified as an appointment request to the promotion notification, the automatic promotion and appointment processing server 200 checks the present appointment schedules, schedules an appointment if the idle resource is still available, or if another appointment has already been made for another customer or the idle resource has otherwise become unavailable, notifies the customer that the appointment is not possible (S170).

Furthermore, when the customer's response type is classified as the denial of the promotion notification, the automatic promotion and appointment processing server 200 updates customer information stored in the customer information DB with promotion notification reception denial and transmits a confirmation to the customer for the denial request (S180).

Furthermore, when the customer's response type is classified as an administrator review, the automatic promotion and appointment processing server 200 provides the customer response to an administrator so that the administrator manually processes the customer response (S190).

As described above, promotion history information is finally updated with the results of processing of an appointment request, a promotion denial, or an administrator review.

In accordance with an embodiment of the present disclosure, the customers' response rate and appointment acceptance rate to promotion notifications can be significantly increased while minimizing customers' complaints because a business establishment providing appointment-based services can promote idle resources to optimal target customers only selected based on the past service records.

Furthermore, operation efficiency of a service business establishment can be maximized because the selection of optimal target customers, the delivery of promotion notifications, the analysis of customer responses, and processing of corresponding appointment requests, are automated.

Furthermore, accuracy in the selection of target customers can be continuously improved by analyzing and using customer's response types to promotion notifications through machine learning for selecting target customers in the future.

As described above, although the present disclosure has been described in connection with the limited embodiments and drawings, the present disclosure is not limited to the embodiments and drawings. A person having ordinary skill in the art to which the present disclosure pertains may modify and change the present disclosure within the technical spirit of the present disclosure and the equivalent range of the following claims.

What is claimed is:

1. A system for automated promotion and reservation of an appointment-based service, the system comprising:
an appointment management database configured to store a service schedule, customer information, and promotion history information; and
an automatic promotion and appointment processing server configured to select a target customer able to use an idle resource and a promotion service item of the idle resource, and to provide the promotion service item to a customer terminal, wherein the idle resource is a service resource for providing the appointment-based service without a scheduled appointment for a specific period of time,
wherein the customer terminal is configured to present the promotion service item of the idle resource provided by the automatic promotion and appointment processing server, and to provide a request, a denial or a change for an appointment from the target customer through the Internet, a mobile communication network, or a communication network formed of a combination of heterogeneous communication networks, and
wherein the automatic promotion and appointment processing server comprises:
an idle resource identification circuit configured to identify the idle resource from one or more service resources based on a set of criteria for determining the idle resource;
a promotion service recommendation circuit configured to select the target customer able to use the idle resource and the promotion service item for the corresponding idle resource;
a promotion notification transceiver circuit configured to transmit a promotion notification of the promotion service item to the target customer selected by the promotion service recommendation circuit and to receive a response from the target customer if the response is present;
a customer response analysis circuit configured to analyze the target customer's response to the promotion notification recommended and transmitted to the target customer, classify the customer's response as an appointment request when the target customer's response includes content to request the appointment, classify the target customer's response as a promotion denial when the target customer's response includes a denial of the promotion notification, and to classify the target customer's response as an administrator review that requires a confirmation by an administrator when a requested service resource or idle resource included in the target customer's response is different from the service resource or the idle resource included in the promotion notification transmitted to the target customer;
a promotion appointment processing circuit configured to schedule the appointment when the customer response analysis circuit classifies the target customer's response to the promotion notification as the appointment request and to transmit the scheduled appointment to the target customer;
a promotion denial processing circuit configured to mark customer information stored in the appointment management database as promotion notification denial when the customer response analysis circuit classifies the target customer's response as the promotion denial; and
an administrator notification circuit configured to provide the customer's response to an administrator terminal when the customer response analysis circuit classifies the target customer's response as the administrator review.

2. The system of claim 1, wherein the appointment management database comprises:
a service schedule database configured to store details of past services and future appointment schedules;
a customer information database configured to store information on customers who use the one or more service resources; and
a promotion history information database configured to store information of promotion notifications provided to the customers and customers' response times and response types to the promotion notifications,
wherein the customer information comprises a name and telephone number of the customer, a unique ID or username of a messenger or social network service preferred by the customer, information on whether the customer wants to receive promotion notifications, and a method for the customer to receive promotion notifications.

3. The system of claim 2, wherein the set of criteria for determining the idle resource in the idle resource identification circuit comprises a time gap from a current time and a minimum time duration that can be determined as the idle resource.

4. The system of claim 2, wherein the promotion service recommendation circuit comprises:
a machine learning circuit configured to analyze customer information and promotion history information stored in the appointment management database and to execute machine learning so that a plurality of target customers expected to have a highest selection rate for accepting promotion notifications is predicted when the idle resource is identified among the one or more service resources, and
a recommendation execution circuit configured to select the target customer and the corresponding promotion service item of the idle resource predicted by the machine learning circuit when the corresponding idle resource is identified.

5. The system of claim 2, wherein the promotion notification transceiver circuit transmits the promotion notification in a real-time notification form to a dedicated terminal installed on a customer side based on a notification method registered in customer information, transmits the promotion notification in a message form through SMS or MMS, or transmits the promotion notification using a different messaging service requested by the customer as the method of receiving the promotion notification by the customer.

6. A method for automating promotion and reservation of an appointment-based service, the method comprising:
a first step of setting, by an automatic promotion and appointment processing server, a condition for determining an idle resource, wherein the idle resource is a service resource for providing the appointment-based service without a scheduled appointment for a specific period of time;
a second step of recognizing, by the automatic promotion and appointment processing server, the idle resource satisfying the set condition;
a third step of automatically recommending, by the automatic promotion and appointment processing server, a target customer according to a machine learning-based algorithm when the idle resource is recognized;
a fourth step of transmitting, by the automatic promotion and appointment processing server, a promotion notification to a customer terminal of the target customer;
a fifth step of analyzing and classifying, by the automatic promotion and appointment processing server, a received response by type when the response is received from the customer terminal; and
a sixth step of handling, by the automatic promotion and appointment processing server, the received response by type,
wherein in the fifth step, the target customer's response is classified as an appointment request when content to request an appointment is included in the target customer's response, the target customer's response is classified as a promotion denial when a denial of promotion notification is included in the content, and the target customer's response is classified as an administrator review that requires a confirmation by an administrator when a requested service resource or idle resource included in the target customer's response is different from the service resource or the idle resource of the promotion notification transmitted to the target customer, and
wherein in the sixth step, a corresponding appointment is registered with a service schedule database when the target customer's response is classified as the appointment request, promotion notification reception denial is registered with a customer information database when the target customer's response is classified as the promotion denial, and the target customer's response is provided to the administrator when the target customer's response is classified as the administrator review.

7. The method of claim 6, further comprising:
transmitting, by the automatic promotion and appointment processing server, a corresponding confirmation notification to the target customer using a communication method requested by the target customer after classifying and handling of the target customer's response; and
storing, by the automatic promotion and appointment processing server, the target customer's response contents and results regarding classifying and handling of all the target customer responses in an appointment management database.
